(19) United States
(12) Patent Application Publication
(10) Pub. No.: US 2013/0007490 A1
(43) Pub. Date: Jan. 3, 2013

(54) MULTICORE PROCESSOR SYSTEM, POWER CONTROL METHOD, AND COMPUTER PRODUCT

(75) Inventors: Koichiro Yamashita, Hachioji (JP); Hiromasa Yamauchi, Kawasaki (JP); Kiyoshi Miyazaki, Machida (JP); Takahisa Suzuki, Kawasaki (JP); Koji Kurihara, Kawasaki (JP)

(73) Assignee: FUJITSU LIMITED, Kawasaki-shi (JP)

(21) Appl. No.: 13/608,001

(22) Filed: Sep. 10, 2012

Related U.S. Application Data
(63) Continuation of application No. PCT/JP2010/054251, filed on Mar. 12, 2010.

(51) Int. Cl. G06F 1/32; G06F 15/76

(52) U.S. Cl. 713/320; 712/32; 712/E09.001

(57) ABSTRACT

A multicore processor system having multiple cores, includes processors configured to measure bandwidth of a network; compare the measured bandwidth and a given threshold; determine among the cores and based on an obtained comparison result, a core adjustment number by which the number of cores executing a given process related to data communicated through the network is adjusted; calculate the number of executing cores after adjustment by the core adjustment number and based on the number of cores executing the given process before the adjustment and the determined core adjustment number; specify a core executing the given process among the cores and based on the calculated number of executing cores after the adjustment; and distribute the communicated data to the specified core executing the given process.

### CROSS REFERENCE TO RELATED APPLICATIONS

This application is a continuation application of International Application PCT/JP2010/054251, filed on Mar. 12, 2010 and designating the U.S., the entire contents of which are incorporated herein by reference.

### FIELD

The embodiments discussed herein are related to a multicore processor system, a power control method, and a power control program that control power.

### BACKGROUND

Recently, accompanying increases in the speed of networks, moving image delivery services where a large volume of streaming data is delivered from a server, received by a receiving terminal and played, have spread. Correspondingly, bandwidth speed is increasing in radio networks represented by Long Term Evolution (LTE) and WiMax (IEEE 802.16).

The following techniques have been disclosed as techniques of efficiently receiving such large volumes of data. A technique has been disclosed that improves overall efficiency by concurrently downloading multiple content items when excess bandwidth is available (see, for example, Japanese Laid-Open Patent Publication No. 2004-151149). A technique has been disclosed that includes multiple Direct Memory Accesses (DMAs) to concurrently transfer received data to applications (see, for example, Japanese Laid-Open Patent Publication No. 2008-299439). A scheduling technique has been disclosed that changes the priority of a thread depending on the bandwidth between a public line and a server in a terminal apparatus that access multiple servers (see, for example, Japanese Laid-Open Patent Publication No. 2000-112858).

Various power-saving techniques are applied to mobile terminals. The period of operation can be extended by suppressing power consumption. If the period of operation is the same, the battery size can be reduced by suppressing power consumption and the overall weight and bulk of the mobile terminal can be reduced.

A technique of varying the number of operating central processing units (CPUs) by a mechanism that monitors power-source connection configuration and a heat sensor to achieve the most efficient operation has been disclosed as a power-saving technique (see, for example, Japanese Laid-Open Patent Publication No. H9-138716). A technique has also been disclosed that preliminarily accumulates statistical values of the load necessary for a process to control the frequency of a CPU based on the statistical value, in an application process causing an adjustment of internal processes while the communication volume is constant (see, e.g., Japanese Laid-Open Patent Publication No. 2009-501482).

However, among the conventional techniques described above, the technique disclosed in Japanese Laid-Open Patent Publication No. 2004-151149 has a problem in that the requirement of a process on the server side makes the technique difficult to implement. The technique according to the Japanese Laid-Open Patent Publication No. 2008-299439 has a problem of excessive DMA processes in the case of a bandwidth that is lower than the processing capacity of DMAs since multiple DMAs are included. The technique according to the Japanese Laid-Open Patent Publication No. 2000-112858 is on the basis of an environment in which bandwidth is secured between a public line and a terminal. While bandwidth is unstable as in the case of mobile terminals, a problem of excessive processes occurs as is the case with Japanese Laid-Open Patent Publication No. 2008-299439.

In terms of the power-saving techniques, the technique according to the Japanese Laid-Open Patent Publication No. H9-138716 realizes power saving by saving a process of a CPU that is to be terminated to another CPU and putting the CPU that is to be terminated in a power-saving mode if the apparatus is moving. However, if a process is saved to another CPU, a saving process of saving a program counter, stack pointer, etc., must be executed. The saving process includes a number of processes and a load is problematically applied in an embedded environment having a relatively lower processing ability such as a mobile terminal. The technique according to the Japanese Laid-Open Patent Publication No. 2009-501482 requires load characteristics of data and therefore, has a problem in that the technique is inapplicable to versatile data without load characteristics.

The techniques according to Japanese Laid-Open Patent Publication Nos. 2004-151149, 2008-299439, 2000-112858, H9-138716, and 2009-501482 focus attention on how the throughput of access is improved under the environment where the bandwidth between a public line and a terminal is stable and secured. Bandwidth significantly fluctuates in mobile terminals due to radio wave conditions etc. The techniques according to Japanese Laid-Open Patent Publication Nos. 2004-151149, 2008-299439, 2000-112858, H9-138716, and 2009-501482 have a problem in that applications cannot be operated stably if the bandwidth significantly fluctuates.

### SUMMARY

According to an aspect of an embodiment, a multicore processor system having multiple cores, includes processors configured to measure bandwidth of a network; compare the measured bandwidth and a given threshold; determine among the cores and based on an obtained comparison result, a core adjustment number by which the number of cores executing a given process related to data communicated through the network is adjusted; calculate the number of executing cores after adjustment by the core adjustment number and based on the number of cores executing the given process before the adjustment and the determined core adjustment number; specify a core executing the given process among the cores and based on the calculated number of executing cores after the adjustment; and distribute the communicated data to the specified core executing the given process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a hardware configuration of a multicore processor system according to an embodiment;

FIG. 2A is an explanatory diagram of a communication bandwidth of a multicore processor system 100;

FIGS. 2B and 2C are explanatory diagrams of states of a portion of the hardware and software corresponding to the communication bandwidth of the multicore processor system 100;

FIG. 3 is a block diagram of a functional configuration of the multicore processor system 100;

FIG. 4 is an explanatory diagram of CPU usage status and communication buffer usage status in the embodiment;

FIG. 5 is an explanatory diagram of communication buffer usage statuses in a conventional example and the embodiment;

FIG. 6 is a flowchart of a process of a bandwidth monitoring module 215;

FIG. 7 is a flowchart of the process of a CPU scheduler 216; and

FIG. 8 is a flowchart of the process of a buffer scheduler 217.

### DESCRIPTION OF EMBODIMENTS

Preferred embodiments of the present invention will be explained with reference to the accompanying drawings.

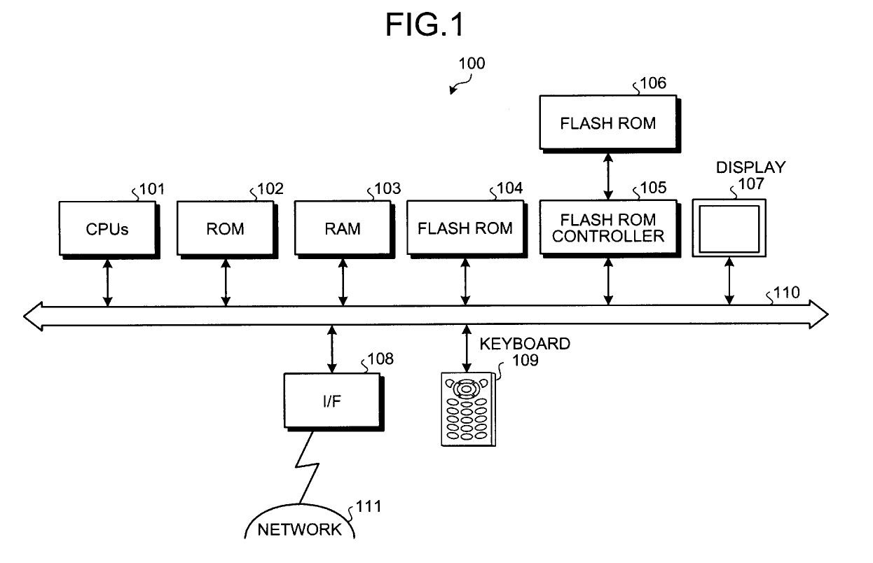

FIG. 1 is a block diagram of a hardware configuration of a multicore processor system 100 according to an embodiment. As depicted in FIG. 1, the multicore processor system 100 includes multiple central processing units (CPUs) 101, read-only memory (ROM) 102, random access memory (RAM) 103, flash ROM 104, a flash ROM controller 105, and flash ROM 106. The multicore process system includes a display 107, an interface (I/F) 108, and a keyboard 109, as input/output devices for the user and other devices. The components of the multicore system are respectively connected by a bus 110.

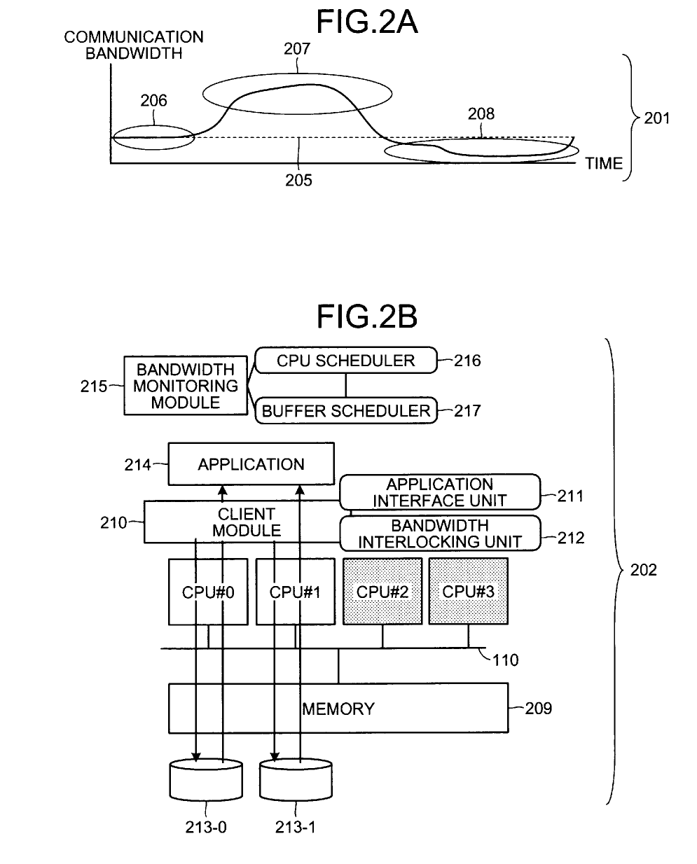

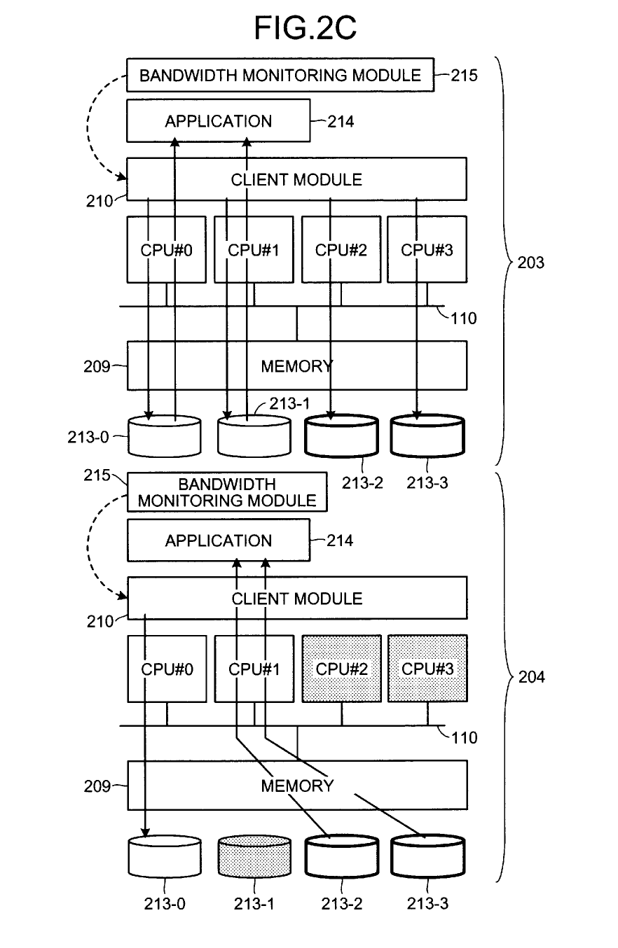

The CPUs 101 govern overall control of the multicore processor system 100. The CPUs 101 refer to CPUs that are single core processors connected in parallel. Details of the CPUs 101 will be described hereinafter with reference to FIG. 2. Further, the multicore processor system 100 is a system of computers that include processors equipped with multiple cores. Provided that multiple cores are provided, implementation may be by a single processor equipped with multiple cores or a group of single-core processors in parallel. For the sake of simplicity, in the present embodiments, description will be given using a processor group constituted by CPUs that are connected in parallel and are single-core processors.

The ROM 102 stores therein programs such as a boot program. The RAM 103 is used as a work area of the CPUs 101. The flash ROM 104 stores system software such as an operating system (OS), and application software. For example, when the OS is updated, the multicore processor system 100 receives a new OS via the I/F 108 and updates the old OS that is stored in the flash ROM 104 with the received new OS.

The flash ROM controller 105, under the control of the CPUs 101, controls the reading and writing of data with respect to the flash ROM 106. The flash ROM 106 stores therein data written under control of the flash ROM controller 105. Examples of the data include image data and video data received by the user of the multicore processor system through the I/F 108. A memory card, SD card and the like may be adopted as the flash ROM 106.

The display 107 displays, for example, data such as text, images, functional information, etc., in addition to a cursor, icons, and/or tool boxes. A thin-film-transistor (TFT) liquid crystal display and the like may be employed as the display 107.

The I/F 108 is connected to a network 111 such as a local area network (LAN), a wide area network (WAN), and the Internet through a communication line and is connected to other apparatuses through the network 111. The I/F 108 administers an internal interface with the network 111 and controls the input/output of data from/to external apparatuses. For example, a modem or a LAN adaptor may be employed as the I/F 108.

The keyboard 109 includes, for example, keys for inputting letters, numerals, and various instructions and performs the input of data. Alternatively, a touch-panel-type input pad or numeric keypad, etc. may be adopted.

FIG. 2A is an explanatory diagram of a communication bandwidth of the multicore processor system 100. FIGS. 2B and 2C are explanatory diagrams of states of a portion of the hardware and software corresponding to the communication bandwidth of the multicore processor system 100. A classification into three states based on an acquired bandwidth of the communication bandwidth will be described with reference to the explanatory diagram denoted by reference numeral 201. The states of hardware and software in each of the states classified in the explanatory diagram denoted by reference numeral 201 will be described with reference to block diagrams denoted by reference numerals 202 to 204.

The explanatory diagram denoted by reference numeral 201 is a graph depicting changes in the communication band over time. The horizontal axis of the graph represents time and the vertical axis represents acquired bandwidth in the communication bandwidth. The communication bandwidth means a communication speed, and a wide bandwidth and a low bandwidth represent a fast communication speed and a slow communication speed, respectively. An acquired bandwidth represents an actual communication speed. A dashed line 205 indicates the value of an average effective bandwidth. For example, when an actually usable average bandwidth is set to about 50 [Mbps] with consideration of a communication method having a theoretical bandwidth of 100 [Mbps], the average effective bandwidth is defined as 50 [Mbps].

In the graph denoted by reference numeral 201, a classification into three states can be made according to a positional relationship between the dashed line 205 and the acquired bandwidth. In the state depicted by a range of reference numeral 206, the acquired bandwidth is equal to the average effective bandwidth and this state is referred to as a steady state. Even when the acquired bandwidth is not completely identical to the average effective bandwidth, for example, a range of the average effective bandwidth may be provided and, a state may be defined as the steady state if the acquired bandwidth is included in the range. For example, the average effective bandwidth may be defined as 50±5 [Mbps] and a state may be defined as the steady state if the acquired bandwidth is within a range of 45 [Mbps] to 55 [Mbps].

In the state indicated by a range of reference numeral 207, the acquired bandwidth is higher than the average effective bandwidth and this state is referred to as a bandwidth raised state. The bandwidth raised state occurs, for example, when the multicore processor system 100 can fully use a line of a base station since the radio wave conditions are favorable and the base station wirelessly connected to the multicore processor system 100 has few other connected terminals.

In the state indicated by a range of reference numeral 208, the acquired bandwidth is lower than the average effective bandwidth and this state is referred to as a bandwidth lowered state. The bandwidth lowered state occurs, for example, when the multicore processor system 100 is hidden behind a building and radio wave conditions deteriorate. If a user carrying the multicore processor system 100 is moving and the base station connected to the multicore processor system 100 is changed, the bandwidth lowered state also occurs. If the base station connected to the multicore processor system 100 has a number of other connected terminals and bandwidth is utilized in a divided manner since concurrent users increase, the bandwidth lowered state also occurs.

The block diagram denoted by reference numeral 202 of FIG. 2B is a block diagram of configurations of a portion of the hardware and software in the steady state denoted by reference numeral 206. First, the configurations of a portion of the hardware and software will be described with reference to the block diagram denoted by reference numeral 202. The block diagram denoted by reference numeral 202 depicts the CPUs 101 and memory 209 as the hardware configuration. The CPUs 101 according to this embodiment are made up of multiple CPUs, which include a CPU #0, a CPU#1, a CPU #2, and a CPU#3. The CPUs and the memory 209 are respectively connected through a bus 110. The memory 209 is a storage device accessed by the CPUs 101 and corresponds to the ROM 102, the RAM 103, and the flash ROM 104.

The CPUs execute software with the hardware configuration described above. The executed software includes a client module 210, an application 214, and a bandwidth monitoring module 215. The software access a buffer 213-0 and a buffer 213-1 in the memory 209.

The client module 210 is a library having a function of executing a process of a presentation layer in an OSI reference model in a communication function. In the process of the presentation layer, data is converted so as to eliminate the necessity for the application 214 to recognize a difference in syntax in terms of communicated data. For example, HyperText Markup Language (HTML) and Extensible Markup Language (XML) coincide with the specifications of the presentation layer. The client module 210 includes an application interface unit 211 and a bandwidth interlocking unit 212 internally. The communicated data may be either data received from the I/F 108 or data transmitted to the I/F 108.

The application interface unit 211 has a function of delivering data to the application 214 at regular intervals without interlocking with a communication bandwidth. The bandwidth interlocking unit 212 has a function of dynamically changing the number of operating CPUs if the bandwidth monitoring module 215 specifies the number of CPUs. The bandwidth interlocking unit 212 also has a function of allocating buffers to the currently operating CPUs and distributing data in the buffers to the CPUs if the number of buffers is changed. The application interface unit 211 and the bandwidth interlocking unit 212 are connected by an asynchronous interface such as that of message communication and first-in, first-Out (FIFO).

The buffer 213-0 and the buffer 213-1 are areas in the memory 209 temporarily storing data communicated through the I/F 108. The buffer 213-0 and the buffer 213-1 are secured by the bandwidth monitoring module 215. The number of buffers secured is dynamically changed if communicated data is data received from the I/F 108.

Although one buffer has an arbitrary size, the size may be set in accordance with the rules of a protocol for exchange by the I/F 108. For example, the maximum size of one packet of data received by the I/F 108 conforms to a maximum transmission unit (MTU), which is the maximum unit transferable in one transfer set in a data link layer. If the MTU is 1500 [bytes], the size of the data portion in the packet is at most 1500 [bytes]. Therefore, if one buffer is configured such that 32 packets of data can be saved, the buffer size is 1500×32=48000 [bytes].

A method of setting the number of packets for one buffer may be set according to the processing ability of the CPU. For example, a CPU is assumed to have a client processing efficiency Cl of 384000 [bits per second] (bps) and to process 48000 [bytes] per second. The CPU is further assumed to read data from a buffer once every second. In this case, since the number of packets that can be processed in one second is 48000/1500=32, the number of packets is set to 32. If the CPU reads data twice every second, the number of packets may be reduced to half, i.e., 16, and the size of the buffer may be 24000 [bytes].

The application 214 is software that performs an operation that a user using a computer wants to execute. When using a communication function, the application 214 accesses the client module 210. Examples of the application 214 include streaming video playing software and a web browser, for example.

The bandwidth monitoring module 215 has a function of monitoring a communication bandwidth for a currently connected server. The bandwidth monitoring module 215 is made up of a periodically activated daemon or thread. The bandwidth monitoring module 215 includes a CPU scheduler 216 and a buffer scheduler 217 internally.

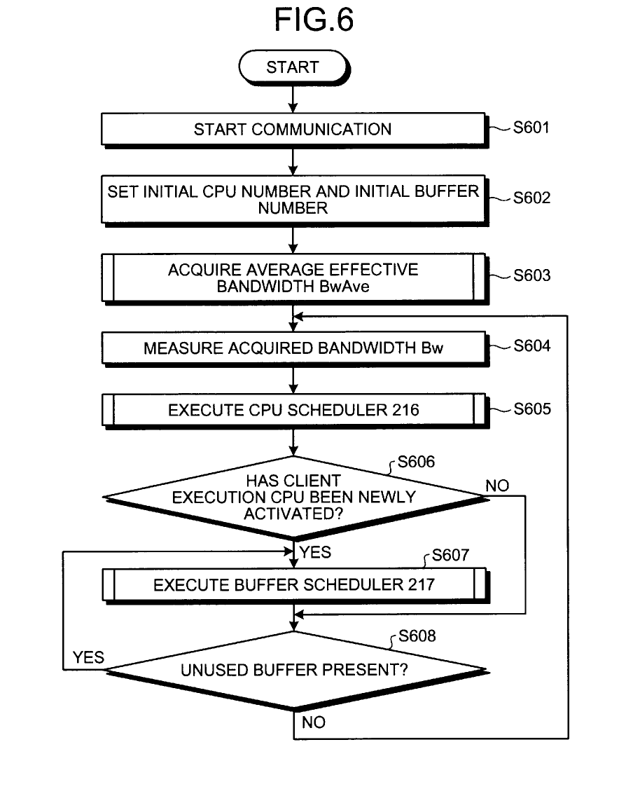

The CPU scheduler 216 calculates the number of CPUs necessary to operate the bandwidth interlocking unit 212 based on the monitoring of the communication bandwidth. The buffer scheduler 217 has a function of securing a buffer if the concurrency of the bandwidth interlocking unit 212 increases, based on the monitoring of the communication bandwidth. The buffer scheduler 217 has a function of releasing a buffer in conjunction with a decrease in buffering data as the process of the application interface unit 211 proceeds. The details of the processes of the bandwidth monitoring module 215, the CPU scheduler 216, and the buffer scheduler 217 will be described later with reference to FIGS. 6, 7, and 8, respectively.

In the hardware and software configurations described above, the multicore processor system 100 realizes the function of the application 214. With regard to the CPUs in the steady state, the CPU #0 and the CPU #1 are in operation and the CPU #2 and the CPU #3 are in a suspended state. The CPU #2 and the CPU #3 are not performing a process related to the application 214 and no other application is running thereon. The CPU #2 and the CPU #3 and are operated in a power-saving mode under the power control. In the block diagram denoted by reference numeral 202, the buffer 213-0 is allocated to the CPU #0 and the buffer 213-1 is allocated to the CPU #1.

The block diagram denoted by reference numeral 203 in FIG. 2C is a block diagram of configurations of a portion of the hardware and software in the bandwidth raised state denoted by reference numeral 207. The bandwidth monitoring module 215 detects the bandwidth raised state and provides cancelation control of the power-saving mode for the CPU #2 and the CPU #3 to the client module 210. The client module 210 cancels the power-saving mode of the CPU #2 and the CPU #3.

The bandwidth monitoring module 215 notifies the application interface unit 211 of the client module 210 of the number of buffers and the application interface unit 211 secures a buffer 213-2 and a buffer 213-3. The secured buffers are allocated to the CPUs by the bandwidth interlocking unit 212. In the block diagram denoted by reference numeral 203, the buffer 213-2 is allocated to the CPU #2 and the buffer 213-3 is allocated to the CPU #3.

The block diagram denoted by reference numeral 204 of FIG. 2C is a block diagram of configurations of a portion of the hardware and software in the bandwidth lowered state denoted by reference numeral 208. The bandwidth monitoring module 215 detects the bandwidth lowered state and controls the client module 210 such that the CPU #2 and the CPU #3 are operated in the power-saving mode.

The bandwidth monitoring module 215 monitors the status of usage of the buffer 213-0, the buffer 213-1, the buffer 213-2, and the buffer 213-3 and checks for an unused buffer. In the block diagram denoted by reference numeral 204, the buffer 213-1 is not used and the application interface unit 211 releases the buffer 213-1. Because the buffers are reduced, the buffers are re-allocated to the CPUs by the bandwidth interlocking unit 212. In the block diagram denoted by reference numeral 204, the buffer 213-0 is allocated to the CPU #0 and the buffer 213-2 and the buffer 213-3 are allocated to the CPU #1.

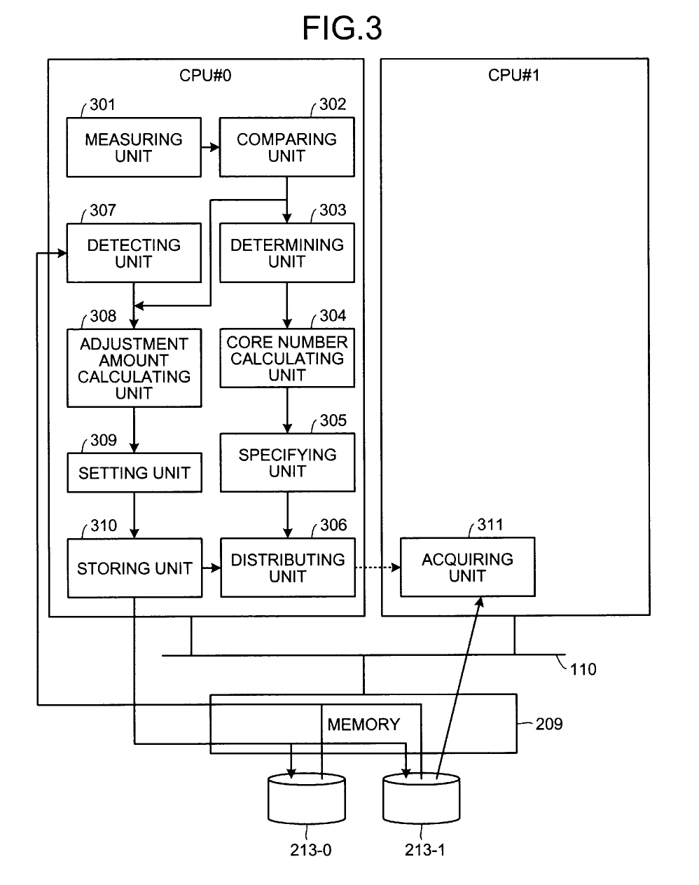

A functional configuration of the multicore processor system 100 will be described. FIG. 3 is a block diagram of the functional configuration of the multicore processor system 100. The multicore processor system 100 includes a measuring unit 301, a comparing unit 302, a determining unit 303, a core number calculating unit 304, a specifying unit 305, a distributing unit 306, a detecting unit 307, an adjustment amount calculating unit 308, a setting unit 309, a storing unit 310, and an acquiring unit 311. The functions (the measuring unit 301 to the acquiring unit 311) acting as a control unit, for example, are implemented by the CPUs 101 executing programs stored in storage devices such as the ROM 102, the RAM 103, and the flash ROM 104 depicted in FIG. 1. The functions may be implemented by another CPU executing the programs via the I/F 108.

Although the CPU #0 has the functions of the measuring unit 301 to the storing unit 310 and the CPU #1 has the function of the acquiring unit 311 in FIG. 3, the CPU #0 also has the acquiring unit 311 when executing the client module 210. The measuring unit 301 to the core number calculating unit 304, the detecting unit 307, and the adjustment amount calculating unit 308 belong to the bandwidth monitoring module 215, and the specifying unit 305, the distributing unit 306, the setting unit 309, the storing unit 310, and the acquiring unit 311 belong to the client module 210. This embodiment will be described with respect to a state where the bandwidth monitoring module 215 is executed by the CPU #0. The bandwidth monitoring module 215 may be executed by another CPU among the CPU #1 to the CPU #3 or may be executed by an external CPU different from the CPU #0 to the CPU #3.

The measuring unit 301 has a function of measuring bandwidth of a network. The CPU #0 transmits a ping to the I/F 108 at a constant frequency to measure bandwidth with a response from a server. The CPU #0 may make the measurement from an amount of data transmitted or received in a certain period, other than the measuring method using the ping. The measured data is stored in a storage area such as the RAM 103 and the flash ROM 104.

The comparing unit 302 has a function of comparing the bandwidth measured by the measuring unit 301 and a given threshold value. For example, when the average effective bandwidth is 50 [Mbps], if the measured bandwidth is 60 [Mbps] and exceeds the given threshold value, the multicore processor system 100 is in the bandwidth raised state. If the measured bandwidth is 40 [Mbps] and falls below the given threshold value, the multicore processor system 100 is in the bandwidth lowered state. If the measured bandwidth is 50 [Mbps] and is equal to the given threshold value, the multicore processor system 100 is in the steady state. Comparison results are stored to a storage area such as in the RAM 103 and the flash ROM 104.

The determining unit 303 has a function of determining a core adjustment number indicative of the number of cores to be increased/decreased to execute a given process related to data communicated through a network among multiple cores, based on a comparison result of the comparing unit 302. The cores correspond to the CPU #0 to the CPU #3 in this embodiment. The given process is a process executed by the client module 210 and is a process of the presentation layer, for example. Process details may be those of a process of another layer.

For example, in the case of transmission to the I/F 108, a Secure Sockets Layer (SSL) may be executed that is a session layer. If the application 214 is streaming video playing software, the transmitted or received data may be a Real Time Streaming Protocol (RTSP) controlling streaming video in an application layer. For the transmitted or received data, a real-time Transport Protocol (RTP) may be used that manages streaming data in a transport layer.

As an example of the determining unit 303, the state of the multicore processor system 100 is assumed to be defined as the bandwidth raised state based on the comparing unit 302, for example. The determining unit 303 determines that the number of CPUs executing the client module 210 is to be increased by one. The determined number of CPUs is stored in a storage area such as in the RAM 103 and the flash ROM 104.

The core number calculating unit 304 has a function of calculating the number of executing cores after the adjustment, based on the number of cores executing the given process before the adjustment and the core adjustment number determined by the determining unit 303. For example, if the number of CPUs executing the client module 210 before the adjustment is two and the number of CPUs is increased by one by the determining unit 303, the number of CPUs after the adjustment is three. The calculated result is stored in a storage area such as in the RAM 103 and the flash ROM 104.

The specifying unit 305 has a function of specifying a core executing a given process among the cores, based on the number of executing cores after the adjustment calculated by the core number calculating unit 304. For example, assuming that the CPU #0 and the CPU #1 execute the client module 210 and are client execution CPUs before the adjustment, in this case, if the number of the executing CPUs after the adjustment is calculated as three, the CPU #0 specifies either the CPU #2 or the CPU #3 currently not executing the client module 210 as a new client execution CPU via the specifying unit 305. Information of the specified CPU is stored in a storage area such as in the RAM 103 and the flash ROM 104.

The distributing unit 306 has a function of distributing communicated data to the core that is specified by the specifying unit 305 and is executing the given process. The distributing unit 306 may distribute data stored in the storage area after the adjustment of the cores executing the given process, depending on the storage area after the adjustment stored to by the storing unit 310. For example, if the CPU #0 and the CPU #1 execute the client module 210, the distributing unit 306 distributes the buffer 213-0 storing communicated data to the CPU #0 and the buffer 213-1 storing communicated data to the CPU #1. Distribution results are stored to a storage area such as in the RAM 103 and the flash ROM 104.

The detecting unit 307 has a function of detecting available space in a given storage area. The given storage area is a currently established buffer among the buffers 213-0 to 213-3. For example, when the buffer 213-0 and the buffer 213-1 are secured, if data received by a client execution CPU is released and generates available space corresponding to one buffer, the detecting unit 307 detects the available space corresponding to one buffer. Information of the detected available space is stored to a storage area such as in the RAM 103 and the flash ROM 104.

The adjustment amount calculating unit 308 has a function of calculating an adjustment amount of the given storage area based on a decreased amount acquired by converting the amount of available space detected by the detecting unit 307 into a given unit, and the amount of received data. If the comparing unit 302 indicates that the measured bandwidth exceeds a given threshold value, the adjustment amount calculating unit 308 may add a given increased amount to make the calculation. The given increased amount is a data amount corresponding to one buffer and the given unit is an amount on the basis of one buffer.

For example, if the available space is 60000 [bytes] and the buffer size of one buffer is 48000 [bytes], a decrease amount is 60000/48000=1 with a reminder of 12000 [bytes] and therefore, the amount of available space is one buffer. In an example of the adjustment amount calculating unit 308, for example, when the measured acquired bandwidth exceeds the average effective bandwidth, if the detected available space corresponds to one buffer and received data also corresponds to one buffer, an adjustment amount is 1+(−1)+1=1. Calculated values are stored to a storage area such as in the RAM 103 and the flash ROM 104.

The setting unit 309 has a function of setting, as the given storage area, a storage area after the adjustment, based on the adjustment amount of the given storage area calculated by the adjustment amount calculating unit 308. For example, the multicore processor system 100 is assumed to have secured two buffers, i.e., the buffer 213-0 and the buffer 213-1. If an adjustment amount is one, the CPU #0 newly secures the buffer 213-2 to turn the number of buffers to three and defines the buffers 213-0 to 213-2 as the storage area after the adjustment. The CPU #0 sets the storage area after the adjustment as a given storage area, which is subject to detection by the detecting unit 307.

The storing unit 310 has a function of storing the received data into the storage area after the adjustment set by the setting unit 309. The received data may be data transmitted through a network. For example, the CPU #0 stores received data into the buffer 213-0 or the buffer 213-1.

The acquiring unit 311 has a function of acquiring communicated data distributed by the distributing unit 306. For example, the CPU #1 specified as the client execution CPU by the specifying unit 305 acquires the data communicated by the buffer 213-1.

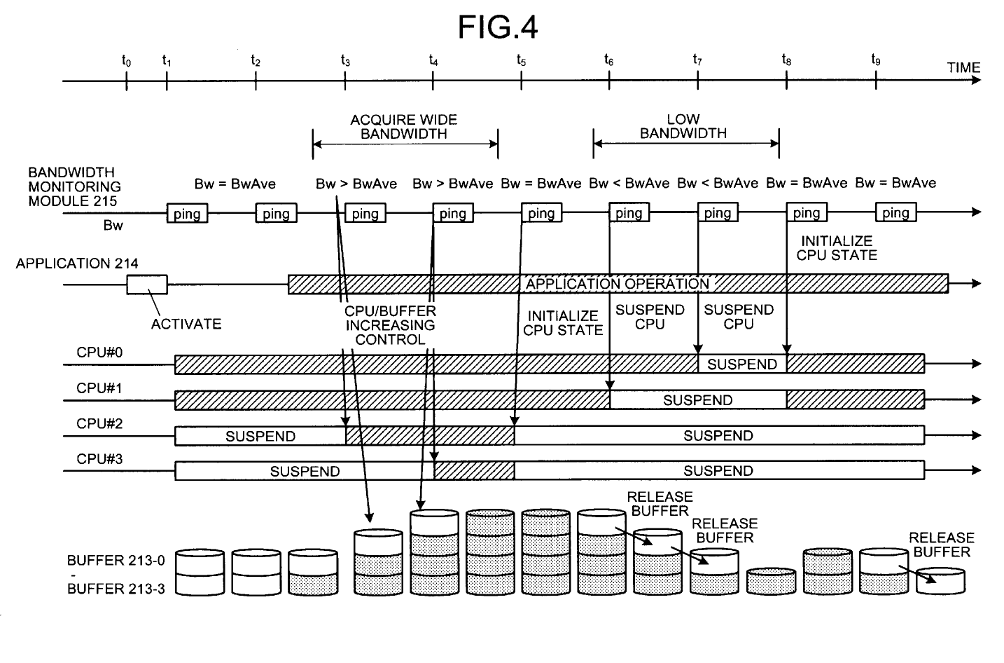

FIG. 4 is an explanatory diagram of CPU usage status and communication buffer usage status in this embodiment. The multicore processor system 100 activates the application at time t0. The multicore processor system 100 allocates two CPUs among the CPUs #0 to #3 to the process of the client module 210 as the initial state. The multicore processor system 100 secures two buffers among the buffers 213-0 to 213-3.

After time t1 when the application 214 is completely activated, the multicore processor system 100 starts the bandwidth monitoring via the bandwidth monitoring module 215. As a result of the bandwidth monitoring, at time t1 and time t2, the multicore processor system 100 is in the steady state, where the acquired bandwidth Bw is equal to an average effective bandwidth BwAve, and allocates the CPU #0 and the CPU #1 to the process of the client module 210. The multicore processor system 100 secures two arbitrary buffers among the buffers 213-0 to 213-3.

At time t3 and time t4, the acquired bandwidth Bw is a wide bandwidth exceeding the average effective bandwidth BwAve and the multicore processor system 100 turns to the bandwidth raised state. At time t3, the multicore processor system 100 allocates the CPU #2 to the process of the client module 210 and newly secures one unused buffer among the buffers 213-0 to 213-3. At time t4, similarly, the multicore processor system 100 allocates the CPU #3 to the process of the client module 210 and newly secures one unused buffer among the buffers 213-0 to 213-3.

At time t5, as a result of the bandwidth monitoring, the multicore processor system 100 turns to the steady state. The multicore processor system 100 turning to the steady state cancels the allocation of the CPU #2 and the CPU #3 to the process of the client module 210 and puts the CPU #2 and the CPU #3 into the suspended state if no other process is executed. The buffers 213-0 to 213-3 are all in use and therefore, not released.

At time t6 and time t7, the acquired bandwidth Bw is a low bandwidth lower than the average effective bandwidth BwAve and the multicore processor system 100 turns to the bandwidth lowered state. At time t6, the multicore processor system 100 cancels the allocation of the CPU #1 to the process of the client module 210 and puts the CPU #1 into the suspended state if no other process is executed. If an unused buffer exists, the buffer is released.

At time t7, the multicore processor system 100 cancels the allocation of the CPU #0 to the process of the client module 210 and puts the CPU #0 into the suspended state if no other process is executed. Since the bandwidth monitoring module 215 etc., operate in the CPU #0 in this embodiment, the CPU #0 does not completely suspended and, for example, the CPU #0 lowers a clock frequency of the CPU and operates in the power-saving mode. Each time an unused buffer is detected among the buffers 213-0 to 213-3, the multicore processor system 100 releases the buffer.

At time t8, the acquired bandwidth Bw becomes equal to the average effective bandwidth BwAve and the multicore processor system 100 turns to the steady state. The multicore processor system 100 is in the initial state and allocates the CPU #0 and the CPU #1 to the process of the client module 210. With regard to the buffers, the multicore processor system 100 performs operation to secure two arbitrary buffers among the buffers 213-0 to 213-3. At time t9, the multicore processor system 100 is in the steady state and continues the execution of the application 214. If an unused buffer is detected, the multicore processor system 100 performs operation to release the unused buffer.

Although not depicted, in a CPU usage status and a communication buffer usage status in a conventional example, a multicore processor in the conventional example turns to an excessive operation state in the steady state and the bandwidth lowered state. In the excessive operation state, if a process is lower than a client processing efficiency that is a processing efficiency of a CPU, the process is completely completed and the multicore processor enters a state of waiting for data for a given period. The occurrence of the state of waiting for data generates a spin loop for periodically checking whether data has been acquired.

For example, in Japanese Laid-Open Patent Publication No. 2008-299439, an error such as data under flow occurs during DMA setting and an overhead of recovery is generated. As a result, in the excessive operation state, wasteful power consumption occurs due to the overhead described above.

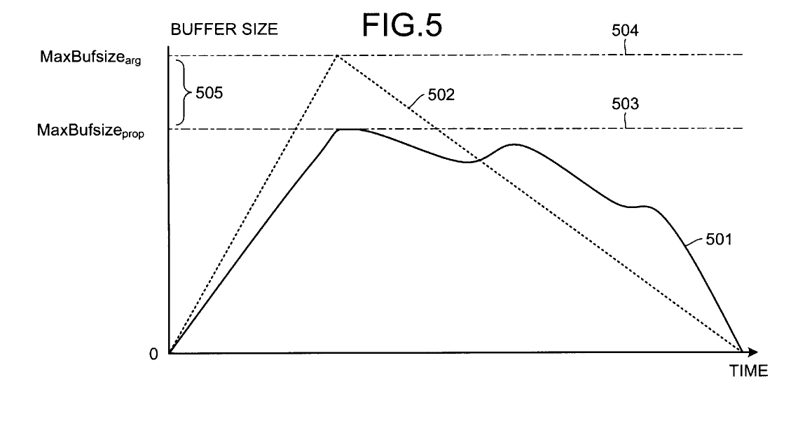

FIG. 5 is an explanatory diagram of communication buffer usage statuses in a conventional example and the embodiment. The horizontal axis of a graph represents the time from the start time of data reception and the vertical axis represents buffer size. A solid line 501 indicates usage status associated with a temporal change in the communication buffer in this embodiment and a dashed line 502 indicates usage status associated with a temporal change in the communication buffer in the conventional example. A dashed-dotted line 503 indicates a maximum value MaxBufsizeprop of the communication buffer in this embodiment and a dashed-dotted line 504 indicates a maximum value MaxBufsizearg of the communication buffer in the conventional example. A usage amount Bufsize(t) of the communication buffers is expressed by equation (1).

$$Bufsize ( t ) = \frac{d}{d t} {\int }_{ }^{t} Cl \cdot N ( t ) \cdot f ( t ) d t \qquad ( 1 )$$

In this equation, Cl denotes client processing efficiency [bps]; t denotes time [s]; N(t) denotes operating CU number; and f(t) denotes reception speed [bps]. In this case, the maximum buffer size satisfies the condition expressed by equation (2).

$$\frac{d}{d t} Bufsize ( t ) = 0 \qquad ( 2 )$$

Equation (3) expresses Bufsize(t′) at t=t′ satisfying Equation (2), which is the maximum buffer size in this embodiment.

MaxBufsizeₚᵣₒₚ=Cl·N(t′)·f(t′) (3)

Similarly, equation (4) expresses the maximum buffer size in the conventional example.

$$Max {Bufsize}_{arg} = \frac{Cl}{1 + Cl} \cdot D \qquad ( 4 )$$

In this equation, D denotes a total amount of data. The buffer can be reduced by MaxBufsizearg-MaxBufsizeprop, i.e., a difference denoted by reference numeral 505, as an effect. In this embodiment, the buffer can be reduced by the difference denoted by reference numeral 505 and more efficient operation can be achieved as compared to typical buffer management modes. The client processing efficiency Cl may be obtained by measuring the processing efficiencies of the CPUs #0 to #3 in advance.

For example, assuming that the client processing efficiency Cl is 10 [Mbps]; f(t) is 384 [kbps] to 100 [Mbps]; and time t of reception completion is 600 [seconds], in this case, MaxBufsizeprop is several megabytes. Since operation is performed in the case of MaxBufsizearg such that a larger buffer size is secured when D is larger consequent to equation (4), the difference becomes greater when a data amount is larger.

FIG. 6 is a flowchart of a process of the bandwidth monitoring module 215. The CPU #0 executing the bandwidth monitoring module 215 starts communication with the application 214 (step S601). Subsequently, the CPU #0 sets the initial CPU number and the initial buffer number allocated to the client module 210 at the start of the communication (step S602). For example, the CPU #0 allocates a half of all the CPUs and prepares buffers equivalent in number to the CPUs. In this embodiment, the multicore processor system 100 allocates two CPUs and prepares two buffers. The set values are reported to the bandwidth interlocking unit 212 and the application interface unit 211.

After the start of the communication, the CPU #0 acquires the average effective bandwidth BwAve of the communication (step S603). The average effective bandwidth represents an average bandwidth in the started communication standard and, for example, if a theoretical bandwidth is 100 [Mbps], the average effective bandwidth may be defines as 100/2=50 [Mbps].

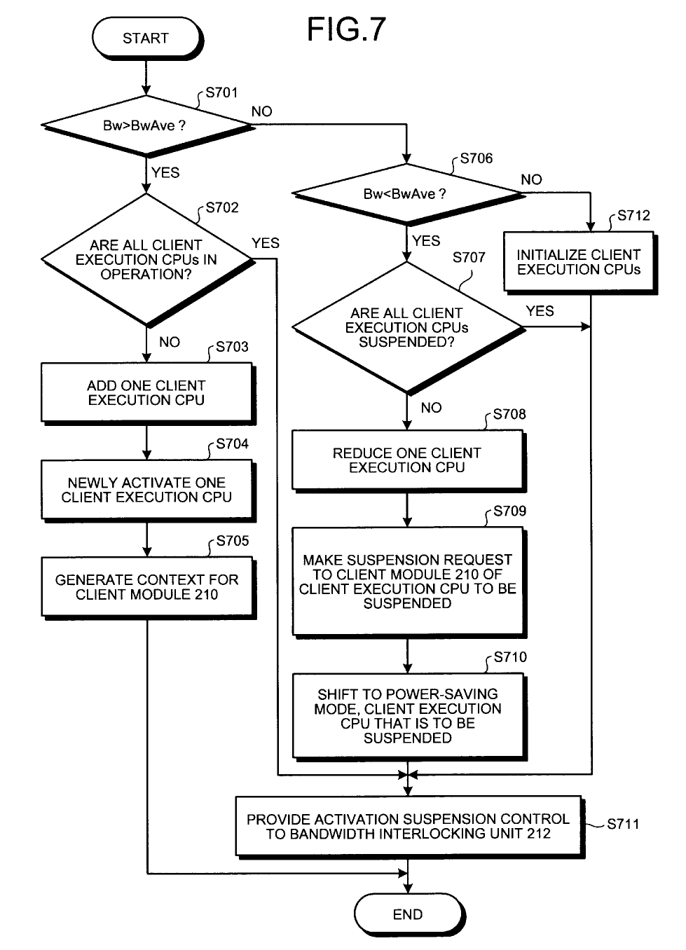

The CPU #0 then measures the acquired bandwidth Bw (step S604). The acquired bandwidth is an actual communication speed and, for example, a ping is sent to measure the acquired bandwidth. After measuring Bw, the CPU #0 executes the CPU scheduler 216 (step S605). The details of the process of the CPU scheduler 216 will be described with reference to FIG. 7. After the process of the CPU scheduler 216, the CPU #0 checks whether a client execution CPU has been newly activated in the process of the CPU scheduler 216 (step S606).

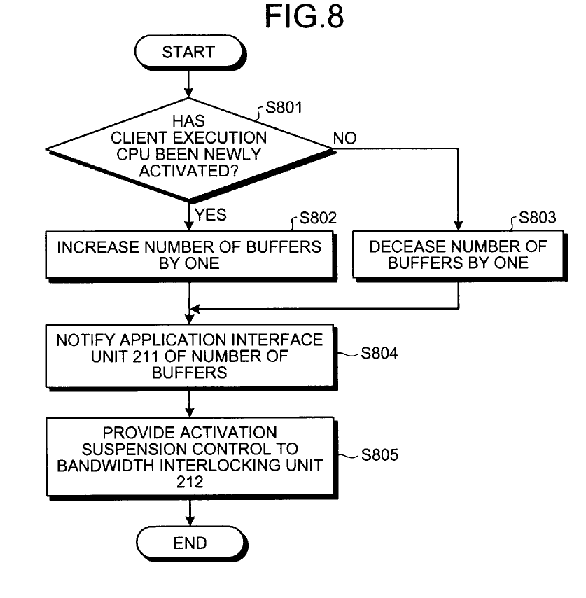

If activated (step S606: YES), the CPU #0 executes the buffer scheduler 217 (step S607). The details of the process of the buffer scheduler 217 will be described later with reference to FIG. 8. After the operation at step S607, or if no client execution CPU under operation (step S606: NO), the CPU #0 detects whether an unused buffer is present as a result of release of received data from the buffers (step S608). If the presence of an unused buffer is detected (step S608: YES), the CPU #0 goes to the operation at step S607. If no unused buffer exists (step S608: NO), the CPU #0 goes to the operation at step S604.

FIG. 7 is a flowchart of the process of the CPU scheduler 216. The CPU #0 compares Bw and BwAve at steps S701 and S706. If Bw is greater than BwAve (step S701: YES), the CPU #0 checks whether all the client execution CPUs are in operation (step S702). If a client execution CPU not in operation exists (step S702: NO), the CPU #0 adds one client execution CPU (step S703).

After the addition, the CPU #0 newly activates one client execution CPU not in operation as a client execution CPU (step S704). After the activation, the CPU #0 generates context for the client module 210 (step S705). After the completion of the operation at step S705, the CPU #0 terminates the CPU scheduler process. If the process path of step S705 is executed, the client execution CPU is newly activated and, therefore, the CPU #0 executes the path of YES at step S606.

If Bw is equal to or less than BwAve (step S701: NO), the CPU #0 checks whether Bw is smaller than BwAve (step S706). If Bw is smaller than BwAve (step S706: YES), CPU #0 checks whether all of the client execution CPUs are suspended (step S707). If an executing CPU exists (step S707: NO), the CPU #0 reduces one client execution CPU (step S708).

The CPU #0 then makes a suspension request to the client module 210 of the client execution CPU to be suspended among the executing CPUs (step S709). After making the suspension request, the CPU #0 shifts the client execution CPU that is to be suspended, to the power-saving mode (step S710).

The CPU #0 then provides activation suspension control to the bandwidth interlocking unit 212 (step S711) and terminates the process. In the operation at step S711, the CPU #0 notifies the bandwidth interlocking unit 212 of the increased/decreased number of execution CPUs determined at step S708 or step S712 described later. If the process path of step S711 is executed, no client execution CPU is newly activated and, therefore, the CPU #0 executes the path of NO at step S606.

Via the notified bandwidth interlocking unit 212, the CPU #0 adds the increased/decreased number of the notification to the number of CPUs executing the client module 210 before the adjustment to calculate the number of executing CPUs after the adjustment. After the calculation, the CPU #0 specifies the CPUs executing the client module 210 according to the number of CPUs after the adjustment.

In this specifying method, for example, if the number of CPUs is increased, the CPU #0 sets any one of non-executing CPUs as a CPU to execute the client module 210 without changing the executing CPUs before the adjustment. If the number of CPU is decreased, the CPU #0 refers to the buffers allocated to the CPUs among the executing CPUs before the adjustment to detect a buffer having the smallest amount of data received in the buffer. For the CPU accessing the buffer, the CPU #0 cancels the allocation to the client module 210.

After specifying the CPU, the CPU #0 distributes secured buffers to the specified CPU in the client module 210. In the distributing method, for example, if the number of CPUs is increased, since the number of buffers is also increased, a newly secured buffer may be allocated, and the data of the newly secured buffer may be distributed, to a newly allocated CPU. If the number of CPUs is decreased, the CPU #0 allocates a buffer processed by a CPU with the allocation cancelled such that the buffer is processed by a remaining CPU, thereby distributing data among CPUs.

If Bw is equal to BwAve (step S706: NO), the CPU #0 initializes the client execution CPUs (step S712) and goes to the operation at step S711. The initialization of the execution CPUs is the same as at step S602 and, for example, if one CPU operates before step S712, the CPU #0 causes two CPUs to operate according to the initial value. Although the buffers are not initialized, if the number thereof is lower than the initial value, the CPU #0 restores the number to the initial value.

Although the average effective bandwidth is compared to the acquired bandwidth in the determining operations at step S701 and S706, the average effective bandwidth may have a certain width. For example, if the average effective bandwidth is set to 50±5 [Mbps], the operation at step S701 is executed as “Bw>(BwAve+5)” and the operation at step S706 is executed as “Bw<(BwAve−5)”. A width may be provided in this way to execute the operation at step S712 when the average effective bandwidth is substantially equal to the acquired bandwidth.

FIG. 8 is a flowchart of the process of the buffer scheduler 217. The CPU #0 checks whether a client execution CPU has been newly activated (step S801). If a client execution CPU has been newly activated (step S801: YES), the CPU #0 increases the number of buffers by one (step S802). If no client execution CPU has been newly activated (step S801: NO), a result of checking the buffer remaining amount indicates the presence of an unused buffer and the CPU #0 deceases the number of buffers by one (step S803).

After the operation at step S802 or S803, the CPU #0 notifies the application interface unit 211 of the number of buffers (step S804). After the notification, the CPU #0 provides the activation suspension control to the bandwidth interlocking unit 212 (step S805) and terminates the process. In the operation at step S805, the CPU #0 notifies the bandwidth interlocking unit 212 of the increased/decreased number of execution CPUs determined at step S703.

Via the notified application interface unit 211 and the bandwidth interlocking unit 212, the CPU #0 notifies the CPUs executing the client module 210 of the adjustment in buffers. Based on the increased/decreased number indicated in the notification, the CPU #0 sets the buffers after the adjustment. The CPU #0 then distributes the buffers distributed to the CPUs, according to the buffers after the adjustment. For example, if a buffer is increased, the CPU #0 distributes the data stored in the newly secured buffer to an arbitrary CPU executing the client module 210. In this case, since no data exists in the newly secured buffer, the CPU #0 may store a portion of data of an already secured buffer again into the newly secured buffer.

As described above, according to the multicore processor system, the power control method, and the power control program, the number of CPUs processing communicated data is calculated according to the communication bandwidth to distribute the communication data among the CPUs. As a result, an optimum number of CPUs can be operated according to the communication band and lower electric power can be achieved by performing the power control with respect to CPUs not under operation.

If the communication bandwidth exceeds a given threshold value, the multicore processor system may calculate an adjustment amount from a given increased amount of a buffer, available space of a storage area, and a received data amount; set the storage area after the adjustment; and distribute the data of the storage area after the adjustment among the CPUs. As a result, a storage area of a size suitable for the processing ability of the CPUs can be secured and the area used in the storage area can be reduced. Since the amount of the memory 209 is not large in an embedded environment of a mobile terminal etc., it is useful to reduce the amount of memory used.

If the communication bandwidth does not exceed the given threshold value, the multicore processor system may calculate an adjustment amount from the available space of the storage area and a received data amount; set the storage area after the adjustment; and distribute the data of the storage area after the adjustment among the CPUs. As a result, a storage area of a size suitable for the processing ability of the CPUs can be secured and lower electric power can be achieved without falling into the excessive operation state particularly in the case of the steady state or the bandwidth lowered state.

If a buffer allocated to a CPU before migration is allocated to a CPU after migration in the bandwidth lowered state in this embodiment, the processing amount can be reduced. For example, if the buffer is implemented by FIFO of a ring buffer, migrated data include four data, which are the start and end addresses of the buffer, an address indicative of an unprocessed position and a process completed address of data. Since the CPU after migration has a thread executing the same process as the CPU before migration, the thread present in the CPU after migration may be used and therefore, a migrating process is not necessary for data other than the four data described above. This processing amount is smaller than the processing amount in the saving process implemented in Japanese Laid-Open Patent Publication No. H9-138716, for example.

The power control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to the multicore processor system, the power control method, and the power control program, an optimum number of CPUs can be operated according to communication bandwidth and by performing power control with respect to CPUs not operated, lower power consumption can be achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multicore processor system having a plurality of cores, the system comprising processors configured to:
measure bandwidth of a network,
compare the measured bandwidth and a given threshold,
determine among the cores and based on an obtained comparison result, a core adjustment number by which the number of cores executing a given process related to data communicated through the network is adjusted,
calculate the number of executing cores after adjustment by the core adjustment number and based on the number of cores executing the given process before the adjustment and the determined core adjustment number,
specify a core executing the given process among the cores and based on the calculated number of executing cores after the adjustment, and
distribute the communicated data to the specified core executing the given process.

2. The multicore processor system according to claim 1, the processors configured to:
detect available space in a given storage area,
calculate an adjustment amount of the given storage area, when the comparison result indicates that the measured bandwidth exceeds the given threshold value and based on a given increased amount, a decreased amount acquired by converting the amount of detected available space into a given unit, and the amount of data received through the network,
set a storage area after the adjustment as the given storage area based on the calculated adjustment amount of the given storage area, and
store the received data into the set storage area, wherein
the processor, according to the storage area to which the received data is stored, distributes the data stored to the storage area to the core executing the given process.

3. The multicore processor system according to claim 2, wherein
the processor calculates the adjustment amount of the given storage area based on the decreased amount acquired by converting the amount of the detected available space into a given unit and the amount of data received through the network, when the comparison result indicates that the measured bandwidth does not exceed the given threshold value.

4. A power control method executed by a multicore processor system having a plurality of cores, the method comprising:
measuring bandwidth of a network;
comparing the measured bandwidth and a given threshold;
determining among the cores and based on an obtained comparison result, a core adjustment number by which the number of cores executing a given process related to data communicated through the network is adjusted;
calculating the number of executing cores after adjustment by the core adjustment number and based on the number of cores executing the given process before the adjustment and the determined core adjustment number;
specifying a core executing the given process among the cores and based on the calculated number of executing cores after the adjustment; and
distribute the communicated data to the specified core executing the given process.

5. A computer-readable recording medium storing a program for causing a multicore processor system having a plurality of cores to execute a power control process comprising:
measuring bandwidth of a network;
comparing the measured bandwidth and a given threshold;
determining among the cores and based on an obtained comparison result, a core adjustment number by which the number of cores executing a given process related to data communicated through the network is adjusted;
calculating the number of executing cores after adjustment by the core adjustment number and based on the number of cores executing the given process before the adjustment and the determined core adjustment number;
specifying a core executing the given process among the cores and based on the calculated number of executing cores after the adjustment; and
distribute the communicated data to the specified core executing the given process.
